(19) United States
(12) Patent Application Publication
(10) Pub. No.: US 2025/0319427 A1
(43) Pub. Date: Oct. 16, 2025

(54) DISCHARGE ARRANGEMENT AND METHOD FOR HORIZONTAL FILTRATION EQUIPMENT AND HORIZONTAL FILTRATION EQUIPMENT

(71) Applicant: METSO FINLAND OY, Espoo (FI)

(72) Inventor: Lars GRÖNVALL, Trelleborg (SE)

(73) Assignee: METSO FINLAND OY, Espoo (FI)

(21) Appl. No.: 18/862,587

(22) PCT Filed: May 11, 2023
(86) PCT No.: PCT/FI2023/050258

§ 371 Date: Nov. 4, 2024

(30) Foreign Application Priority Data
May 12, 2022 (EP) 22172992.4

(51) Int. Cl. B01D 25/32; B01D 25/12

(52) U.S. Cl. CPC B01D 25/32; B01D 25/12

(57) ABSTRACT

A discharge arrangement for horizontal filtration equipment. The discharge arrangement includes a conveyor configured to be provided below the horizontal filtration equipment for receiving discharge material discharged from the horizontal filtration equipment, and a drive for driving the conveyor. The drive is configured to enable driving the conveyor in two opposite directions. Thereby, material provided on the conveyor can be discharged at either a first end or a second end depending on the direction in which the conveyor is driven.

### TECHNICAL FIELD

The present disclosure relates to horizontal filtration equipment, and more particularly to a discharge arrangement for horizontal filtration equipment and a method for horizontal filtration equipment. The present disclosure further concerns the horizontal filtration equipment.

### BACKGROUND

Industrial filters, such as horizontal filtration equipment, are used in separation processes, more specifically to separate solids and liquids.

Horizontal filtration equipment, such as horizontal filter presses, typically discharge the solids, often called cake(s) or filter cake(s), on a conveyor provided below the filter apparatus, such as filter plates. In traditional horizontal filtration equipment, separate doors, or rotating plates, also called a dispatch hatch, are typically used to prevent liquids from ending up on the conveyor. These doors or plates are only opened, when solids are discharged, and closed at other times.

This kind of doors or rotating plates may be problematic in certain applications. Space for their rotative movement must be reserved between the filter apparatus of the equipment and the conveyor, whereby the solids are dropped from a certain height, setting durability requirements for the conveyor. Moving objects near ground may also increase safety risks for people working there and so on.

### BRIEF DESCRIPTION OF THE DISCLOSURE

An object of the present disclosure is to provide a new discharge arrangement for horizontal filtration equipment, horizontal filtration equipment and method for horizontal filtration equipment.

The object of the disclosure is achieved by a method and an arrangement which are characterized by what is stated in the independent claims. Some embodiments of the disclosure are disclosed in the dependent claims.

The disclosure is based on the idea of providing a dual-action conveyor enabling discharge of both solids and liquids, in other words solid and liquid material(s), on the same conveyor during different phases of a work cycle of the horizontal filtration equipment.

An advantage of the method and arrangement of the disclosure is that a need for opening and closing doors or plates and potential problems related to them are avoided. This also enables providing the filter apparatus of the horizontal filtration equipment to be provided closer to the conveyor, decreasing the wear caused by the solids dropped on the conveyor.

### BRIEF DESCRIPTION OF THE DRAWINGS

In the following the disclosure will be described in greater detail by means of some embodiments with reference to the accompanying drawings, in which

FIG. 1 illustrates schematically horizontal filtration equipment shown from a side;

FIG. 2 illustrates schematically a discharge arrangement according to an embodiment shown from a side;

FIG. 3 illustrates schematically a discharge arrangement according to an embodiment shown from a first end; and

FIG. 4 illustrates a method for horizontal filtration equipment.

### DETAILED DESCRIPTION

The disclosure relates to horizontal filtration equipment 1, to a discharge arrangement 10 for horizontal filtration equipment and to a method for horizontal filtration equipment.

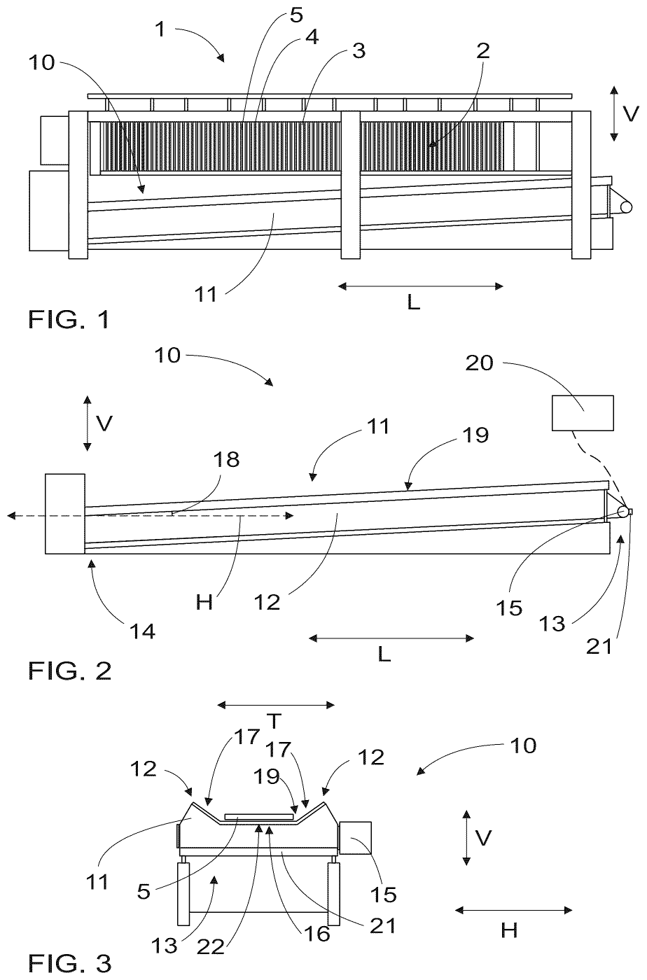

FIG. 1 illustrates schematically horizontal filtration equipment shown from a side. A horizontal filtration equipment 1 may comprise a horizontal filter press or another type of a horizontal filtration equipment. The horizontal filtration equipment may comprise a filter apparatus 2 of the filtration equipment, namely the part of the filtration equipment doing the actual separation of the feed material into liquids and solids, in other words into liquid and solid material(s). The liquid material refers to mostly liquid material and solid material refers to mostly solid material. In other words, liquid material refers to material acting like a liquid material, for instance taking a shape of a receptacle it is placed in, whereas solid material refers to material acting like a solid material, for instance keeping an at least partly fixed shape. It is clear for a person skilled in the art that in connection of this type of processes, there may be a certain amount of solids blended in a liquid and a certain among of moisture contained in a solid material.

According to an embodiment, the filter apparatus may comprise an elongated form extending in horizontal direction in a normal use position of the horizontal filtration equipment 1. A normal use position of the horizontal filtration equipment 1 refers to a position, in which the horizontal filtration equipment 1 is intended to be provided during production use.

A horizontal filtration equipment 1, such as a horizontal filter press, typically comprises a plurality of filter plates 3 extending in a vertical direction and provided adjacent to each other in a horizontal direction. The filter plates 3 are connected to each other in a movable manner, such that the filter plates 3 are movable in relation to each other in a horizontal direction H. More particularly, the filter plates 3 are preferably configured to be pressed against each other in a filtration phase of a work cycle of the filtration equipment 1, forming in each case a filter chamber 4 between two adjacent filter plates 3. During the filtration phase, material to be filtered, slurry, is fed into the filter chambers and liquid filtrate is separated therefrom while the solid contents of the slurry form filter cakes 5 within the filter chambers. The liquid filtrate may be discharged during the filtration phase, during another phase or in a separate phase of the work cycle. Subsequently, in a discharge phase of the work cycle of the filtration equipment 1, the filter plates 3 are moved away from each other to open the filter chambers and to discharge the filter cakes therefrom. When the filter cakes 5 are discharged, the work cycle may start again and the filter plates 3 may again be pressed against each other, and this sequence is then repeated. According to an embodiment, the work cycle of the filtration equipment 1 may further comprise a washing phase. In the washing phase, the filter apparatus 2, such as the filter plates 3 and/or other parts of the filter apparatus, are washed with a liquid. In certain embodiments, the work cycle of the filtration equipment 1 may have different and/or further additional phases not described here. Such filter apparatuses 2 and their filtration principles are known as such, whereby they are not explained here in more detail.

According to an embodiment, a horizontal filtration equipment 1 may comprise a filter apparatus 2 and a discharge arrangement 10.

FIG. 2 illustrates schematically a discharge arrangement 10 according to an embodiment shown from a side, and FIG. 3 illustrates schematically a discharge arrangement 10 according to an embodiment shown from a first end 13.

A discharge arrangement 10 for horizontal filtration equipment, such as the discharge arrangements 10 of FIGS. 2 and 3, may comprise a conveyor 11. The conveyor 11 may be configured to be provided below the horizontal filtration equipment 1, more particularly under the filter apparatus 2, for receiving discharge material discharged from the horizontal filtration equipment 1. According to an embodiment, the conveyor 11 may have an elongated shape, two sides 12 extending in the longitudinal direction L of the conveyor 11, a first end 13 at one end of the sides 12 and a second end 14 at the opposite end of the sides 12.

The discharge arrangement 10 for horizontal filtration equipment may also comprise a drive 15 for driving the conveyor 11. The drive 15 may be configured to enable driving the conveyor 11 in two opposite directions, such that material provided on the conveyor 11 can be discharged at either the first end 13 or the second end 14 depending on the direction in which the conveyor 11 is driven. According to an embodiment, material provided on the conveyor may comprise material discharged from the filtration equipment 1. The material discharged from the filtration equipment may comprise liquid material(s) and/or solid material(s). According to an embodiment, solid material discharged from the filtration equipment 1 may comprise filter cake(s) 5, preferably filter cake(s) 5 comprising minerals. Filter cakes produced by horizontal filtration equipment 1 and comprising minerals are typically heavy and have a low moisture content. According to an embodiment, the drive 15 may comprise an electric drive, a pneumatic drive, a hydraulic drive, or a drive of some other type capable of driving the conveyor 11 in two opposite directions.

According to an embodiment, the conveyor 11 may be configured to receive both liquid and solid material(s). The liquid material(s) may comprise filtrate, water, washing liquid and/or other liquid material(s) received on the conveyor 11. The solids, in other words solid material(s), may comprise filter cake(s), preferably filter cake(s) comprising minerals. According to an embodiment, the conveyor may be configured to receive both filtrate liquid, which thus is a liquid material, and solids such as filter cakes 5, from the horizontal filtration equipment 1.

According to an embodiment, the conveyor 11 may be configured to discharge solid material(s) at one end 13, 14 of the conveyor and the liquid material(s) at the other end. According to an embodiment, solid material(s) may be discharged at the same time as the liquid material(s) but at different ends 13, 14. According to another embodiment, solid material(s) and liquid material(s) may be discharged at different times or time intervals, such as during different phases of the work cycle of the filtration equipment 1. According to an embodiment, the conveyor 11 may be configured to discharge solid material(s) at the first end 13 of the conveyor and the liquid material(s) at the second end 14.

According to an embodiment, the conveyor 11 may be configured to discharge at least one solid material and at least one liquid material at a same end of the conveyor, but at different times of time intervals, such as during different phases of the work cycle.

According to an embodiment, the conveyor 11 may comprise a conveyor belt. According to a further embodiment, the conveyor belt may be bent upwards at both sides 12, such that the conveyor belt has in a transverse direction T a middle part 16 and two side parts 17, one on each side of the middle part 16, such as shown in FIG. 3. Preferably, at least the side parts 17 are bent upwards from a middle point 22 of the conveyor belt. The middle point 22 refers to a point of the longitudinal centre line of the conveyor 11 at a given position along the length of the conveyor. According to an embodiment, the middle part 16 and the side parts 17, and thus the whole conveyor belt bent upwards at both sides, is formed as a uniform and continuous structure. According to an embodiment, the middle part 16 and the side parts 17 are made of a same material. These features are particularly beneficial in embodiments, in which both liquid and solid materials are conveyed by the conveyor 11.

According to an embodiment, the conveyor 11 may be provided at an angle 18 in relation to a horizontal direction H in such a manner that the first end 13 is provided at a higher position than the second end 14 in relation to the horizontal direction H. More particularly, the upper surface 19 of the conveyor 11 configured to receive the material discharged from the filtration equipment 1, such as the filter cake(s) 5, may be provided at the angle 18. In other words, the upper surface 19 of the conveyor 11 at the first end 13 provided higher in a direction of an acceleration due to gravity vector, which is parallel to the vertical direction V, than the upper surface 19 of the conveyor 11 at the second end 14.

According to an embodiment, the discharge arrangement 10 further comprises a control unit 20 configured to control the drive 15 to drive the conveyor 11 alternatively in a first direction and a second direction. According to an embodiment, the first direction is a direction directed towards the first end 13, such that the conveyor 11 is configured to discharge material provided on the conveyor 11 at the first end 13. According to an embodiment, the second direction is a direction directed towards the second end 14, such that the conveyor 11 is configured to discharge material provided on the conveyor 11 at the second end 14. In embodiments, in which the conveyor 11 is provided at an angle 18 with the first end 13 provided at a higher position, the material provided on the conveyor 11 is thus conveyed upwards in the first direction and downwards in the second direction.

According to an embodiment, the control unit 20 is configured to control the drive 15 to drive the conveyor 11 in the first direction in a first phase of a work cycle of the discharge arrangement 10, and thus the work cycle of the filtration equipment 1, and in the second direction in a second phase of the work cycle. According to an embodiment, the first phase of the work cycle comprises a discharge phase, wherein filter cakes 5 received on the conveyor 11 from the horizontal filtration equipment 1 are discharged from the conveyor 11, and wherein the second phase of work cycle comprises a washing phase, wherein washing liquid is received on the conveyor. According to an embodiment, the washing liquid may comprise filtrate collected from the filter apparatus 2.

According to an embodiment, the conveyor 11 may be provided with a cleaning member 21 at least at one end 13, 14 of the conveyor 11. According to an embodiment, the cleaning member 21 may comprise a scraper. The scraper may comprise a scraping blade, plate or other similar structure provided with a surface brought close to or into contact with the upper surface 19 of the conveyor 11. This way, the cleaning member 21 may be configured to clean the upper surface 19 of the conveyor 11 from solids built up and/or stuck onto the upper surface 19 of the conveyor 11. According to an embodiment, the conveyor 11 may be provided with a cleaning member 21 at each end 13, 14 of the conveyor 11. This enables cleaning the conveyor 11 every time it is moved in either the first direction or the second direction. Cleaning the conveyor continuously and/or regularly prevents solids from building up on the upper surface 19 of the conveyor 11. This may lighten the conveyor 11 thus decreasing energy consumption, decrease the wear of the conveyor 11 and lengthen the life cycle of the conveyor.

According to an embodiment, the horizontal filtration equipment 1 may comprise a discharge arrangement 10 according to an embodiment disclosed in this description or a combination of such embodiments.

According to an embodiment, the horizontal filtration equipment 1 may be configured to discharge both filtrate liquid and solids directly onto the conveyor 11. More particularly, the filter apparatus 2 of the filtration equipment 1 may be configured to discharge both filtrate liquid and solids directly onto the conveyor 11. Discharging both filtrate liquid and solids, such as the filter cake(s) 5, directly onto the conveyor 11 refers to an absence of rotating or otherwise movable doors, swivel plates, dispatch hatch or similar structures between the filter apparatus 2 and the conveyor 11, which are typical in traditional filtration equipment 1. Movable and/or rotatable parts are not needed, because it is not necessary to prevent liquids from being provided on the conveyor 11 due to the dual action of the conveyor, namely that the conveyor 11 may be driven, during different phases, in two opposite directions. In other words, the functionality of a dispatch hatch, namely the capability to keep the solids separate from the liquids, is integrated to the conveyor. More particularly, the functionality of a dispatch hatch is integrated to the conveyor in a structural and/or functional manner. The absence of movable doors, swivel plates or similar structures, on the other hand, enables providing the filter apparatus 2 closer to the conveyor 11 in a vertical direction, as no space needs to be reserved for the movement of the movable doors, swivel plates or similar structures. This, on the other hand, enables a shorter discharge distance for the filter cake(s) 5 decreasing the wear and lengthening the life cycle of the conveyor 11. It also improves occupational safety of the people working close to the horizontal filtration equipment 1.

According to an embodiment, the horizontal filtration equipment 1 comprises a horizontal filter press.

According to an embodiment, the discharge arrangement 10 may comprise a structure open towards the filter apparatus 2. In other words, the discharge arrangement 10 may be spaced from the filter apparatus 2 in such manner that the discharge arrangement 10 and the filter apparatus 2 do not form a continuous and/or enclosed structure. According to an embodiment, the discharge arrangement 10 may be configured to be provided at a distance from a lower part of the filter apparatus 2 in such a manner that there is an open space, in other words an uncovered portion, between the sides 12 and/or the ends 13, 14 of the discharge arrangement 10 and the filter apparatus 2.

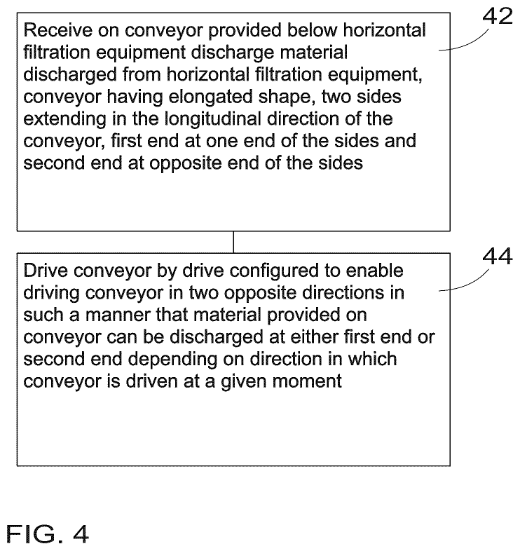

FIG. 4 illustrates a method for horizontal filtration equipment. The method for a horizontal filtration equipment 1 may comprise receiving 42 on a conveyor 11 provided below the horizontal filtration equipment 1 discharge material discharged from the horizontal filtration equipment 1. According to an embodiment, the conveyor 11 may have an elongated shape, two sides 12 extending in the longitudinal direction L of the conveyor 11, a first end 13 at one end of the sides and a second end 14 at the opposite end of the sides.

The method may further comprise driving 44 the conveyor 11 by a drive 15 configured to enable driving the conveyor 11 in two opposite directions in such a manner that material provided on the conveyor 11 can be discharged at either the first end 13 or the second end 14 depending on the direction in which the conveyor 11 is driven at a given moment.

According to an embodiment, the conveyor 11 may be provided at an angle 18 in relation to a horizontal direction H in such a manner that the first end 13 is provided at a higher position than the second end 14 in relation to the horizontal direction H. The drive 15 may be controlled by a control unit 20 to drive the conveyor 11 alternatively in a first direction, which is a direction directed towards the first end 13, such that the conveyor 11 is configured to discharge material provided on the conveyor 11 at the first end 13, and in a second direction, which is a direction directed towards the second end 14, such that the conveyor 11 is configured to discharge material provided on the conveyor 11 at the second end 14. According to an embodiment, the method may further comprise driving the conveyor 11 in the first direction in a first phase of a work cycle of the discharge arrangement, and thus a work cycle of the horizontal filtration equipment, and in the second direction in a second phase of the work cycle.

According to an embodiment, the first phase of the work cycle may comprise a discharge phase, wherein filter cakes 5 received on the conveyor 11 from the horizontal filtration equipment are discharged from the conveyor 11, and wherein the second phase of work cycle comprises a washing phase, wherein washing liquid is received on the conveyor 11. The washing liquid may comprise liquid filtrate collected from the filter apparatus 1 or a separate liquid provided for washing the filter apparatus 2, the conveyor 11 and/or the filtration equipment 1.

According to an embodiment, the method may comprise driving the conveyor 11 in a discharge phase in a first direction, receiving solids, such as filter cake(s) 5, discharged from the filter apparatus 2 on the conveyor 11, conveying the solids upwards towards the first end 13 and discharging the solids from the conveyor at the first end 13. The method may further comprise driving the conveyor 11 in a washing phase in a second direction, receiving liquid material, such as filtrate or a washing liquid, from the filter apparatus 2 on the conveyor 11, conveying the liquid material downwards towards the second end 14 and discharging liquids from the conveyor 11 at the second end 14.

According to an embodiment, the conveyor 11 is provided with a cleaning member 21 at least at one end 13, 14, preferably at both ends 13, 14, of the conveyor 11. According to an embodiment, the method further comprises cleaning the conveyor 11 by cleaning member 21 in each case when the conveyor 11 is driven towards the end 13, 14 provided with the cleaning member 21.

According to an embodiment, the method according to any embodiment disclosed in this description may be implemented by a discharge arrangement 10 according to any one embodiment or a combination of embodiments and/or by a horizontal filtration equipment according to any one embodiment or a combination of embodiments described in this description.

1. A discharge arrangement for horizontal filtration equipment, the discharge arrangement comprising:
a conveyor configured to be provided below the horizontal filtration equipment for receiving discharge material discharged from the horizontal filtration equipment, and
a drive for driving the conveyor, wherein
the drive is configured to enable driving the conveyor in two opposite directions, such that material provided on the conveyor can be discharged at either a first end or a second end depending on the direction in which the conveyor is driven, and that the discharge arrangement further comprises a control unit configured to control the drive to drive the conveyor alternatively in a first direction, which first direction is directed towards the first end, such that the conveyor is configured to discharge material provided on the conveyor at the first end, and in a second direction, which second direction is directed towards the second end, such that the conveyor is configured to discharge material provided on the conveyor at the second end.

2. The discharge arrangement according to claim 1, wherein the conveyor comprises a conveyor belt.

3. The discharge arrangement according to claim 2, wherein the conveyor belt is bent upwards at both sides, such that the conveyor belt has in a transverse direction a middle part and two side parts, one on each side of the middle part, wherein at least the side parts are bent upwards from a middle point of the conveyor belt.

4. The discharge arrangement according to claim 1, wherein the conveyor is provided at an angle in relation to a horizontal direction in such a manner that the first end is provided at a higher position than the second end in relation to the horizontal direction.

5. The discharge arrangement according to claim 1, wherein the conveyor is configured to receive both liquid and solid material(s) from the horizontal filtration equipment.

6. (canceled)

7. The discharge arrangement according to claim 1, wherein the control unit is configured to control the drive to drive the conveyor in the first direction in a first phase of a work cycle of the discharge arrangement and in the second direction in a second phase of the work cycle.

8. The discharge arrangement according to claim 7, wherein the first phase of the work cycle comprises a discharge phase, wherein filter cakes received on the conveyor from the horizontal filtration equipment are discharged from the conveyor, and wherein the second phase of work cycle comprises a washing phase, wherein washing liquid is received on the conveyor.

9. The discharge arrangement according to claim 5, wherein the conveyor is configured to discharge the solid material(s) at one end of the conveyor and the liquid material(s) at the other end.

10. The discharge arrangement according to claim 5, wherein the conveyor is configured to discharge at least one solid material and at least one liquid material at a same end of the conveyor, but at different phase of the work cycle.

11. The discharge arrangement according to claim 1, wherein the conveyor is provided with a cleaning member at least at one end of the conveyor.

12. A horizontal filtration equipment, wherein the horizontal filtration equipment comprises a discharge arrangement according to claim 1 and a filter apparatus.

13. The horizontal filtration equipment according to claim 12, wherein the horizontal filtration equipment is configured to discharge both liquid and solid material(s) directly onto the conveyor.

14. The horizontal filtration equipment according to claim 12, wherein the horizontal filtration equipment comprises a horizontal filter press.

15. The horizontal filtration equipment according to claim 12, wherein the discharge arrangement comprises a structure open towards the filter apparatus.

16. A method for a horizontal filtration equipment, the method comprising:
receiving on a conveyor provided below the horizontal filtration equipment discharge material discharged from the horizontal filtration equipment, the conveyor having an elongated shape, two sides extending in the longitudinal direction of the conveyor, a first end at one end of the sides and a second end at the opposite end of the sides; and
driving the conveyor by a drive configured to enable driving the conveyor in two opposite directions in such a manner that material provided on the conveyor can be discharged at either the first end or the second end depending on the direction in which the conveyor is driven at a given moment.

17. The method according to claim 16, wherein
the conveyor is provided at an angle in relation to a horizontal direction in such a manner that the first end is provided at a higher position than the second end in relation to the horizontal direction, wherein
the drive is controlled by a control unit to drive the conveyor alternatively in a first direction, which is a direction directed towards the first end, such that the conveyor is configured to discharge material provided on the conveyor at the first end, and in a second direction, which is a direction directed towards the second end, such that the conveyor is configured to discharge material provided on the conveyor at the second end, and wherein the method further comprises:
driving the conveyor in the first direction in a first phase of a work cycle of the discharge arrangement and in the second direction in a second phase of the work cycle.

18. The method according to claim 16, wherein the first phase of the work cycle comprises a discharge phase, wherein filter cakes received on the conveyor from the horizontal filtration equipment are discharged from the conveyor, and wherein the second phase of work cycle comprises a washing phase, wherein washing liquid is received on the conveyor.

19. The method according to claim 16, wherein the method is implemented by a discharge arrangement according to claim 1.
